(19) United States
(12) Patent Application Publication
(10) Pub. No.: US 2026/0003483 A1
(43) Pub. Date: Jan. 1, 2026

(54) ENHANCED SUMMARY GENERATION OF DIGITAL CONTENT

(71) Applicant: RAKUTEN KOBO INC., Toronto (CA)

(72) Inventors: Justyna SZTELA-MICHALSKA, Kraków (PL); Nimod NARAYANAN, Toronto (CA); Alyssa ANDINO, Toronto (CA); Gavin POWER, Waterford (IE); Camilo SIERRA, Medellin (CO); Kevin HUGH, Toronto (ON)

(73) Assignee: RAKUTEN KOBO INC., Toronto, ON (CA)

(21) Appl. No.: 19/253,526

(22) Filed: Jun. 27, 2025

Related U.S. Application Data
(60) Provisional application No. 63/665,698, filed on Jun. 28, 2024.

(51) Int. Cl. G06F 3/0484

(52) U.S. Cl. CPC G06F 3/0484

(57) ABSTRACT

A device may provide, during a user session, a graphical user interface (GUI) configured to present digital content to a user associated with the user session. A portion of the digital content may be associated with an interaction that occurred earlier in time than the user session. The device may generate, using an artificial intelligence model configured for summarization, a summary based on the portion of the digital content. The device may present, by the GUI, the summary.

### CROSS-REFERENCE TO RELATED APPLICATION

This application claims the benefit of U.S. Provisional Application No. 63/665,698, filed Jun. 28, 2024, which is incorporated herein by reference in its entirety.

### BACKGROUND

An electronic device may be used to access and present digital content, such as electronic books (e-books), articles, audio, and/or video, to a user. The electronic device may enable the user to interact with and consume the digital content, such as through interactions with a display of the electronic device.

### SUMMARY

Some implementations described herein relate to a method, comprising: providing, during a user session, a graphical user interface (GUI) configured to present digital content to a user associated with the user session, wherein a portion of the digital content is associated with an interaction that occurred earlier in time than the user session; generating, using an artificial intelligence model configured for summarization, a summary based on the portion of the digital content; and presenting, by the GUI, the summary.

Some implementations described herein relate to a device, comprising: a graphical user interface (GUI) configured to present digital content to a user; and circuitry configured to: provide, during a user session, the GUI to the user, wherein a portion of the digital content is associated with an interaction that occurred earlier in time than the user session; generate, using an artificial intelligence model configured for summarization, a summary based on the portion of the digital content; and present, by the GUI, the summary.

Some implementations described herein relate to a non-transitory computer-readable medium storing a set of instructions, the set of instructions comprising: one or more instructions that, when executed by one or more processors of a device, cause the device to: provide, during a user session, a graphical user interface (GUI) configured to present digital content to a user associated with the user session, wherein a portion of the digital content is associated with an interaction that occurred earlier in time than the user session; generate, using an artificial intelligence model configured for summarization, a summary based on the portion of the digital content; and present, by the GUI, the summary.

### BRIEF DESCRIPTION OF THE DRAWINGS

FIGS. 1A-1E are diagrams of an example associated with enhanced summary generation of digital content.

FIG. 2 is a diagram of an example environment in which systems and/or methods described herein may be implemented.

FIG. 3 is a diagram of example components of a device associated with enhanced summary generation of digital content.

FIG. 4 is a flowchart of an example process associated with enhanced summary generation of digital content.

### DETAILED DESCRIPTION

The following detailed description of example implementations refers to the accompanying drawings. The same reference numbers in different drawings may identify the same or similar elements.

A user may use an electronic device (e.g., an electronic reader (e-reader) device and/or an audiobook player device, among other examples) to consume digital content, such as textual content of an electronic book (e-book) or audio content of an audiobook. In practice, users often consume digital content in fragments, engaging with portions of the content over multiple, non-contiguous user sessions rather than completing the content in a single sitting. For example, a user may read several chapters of an e-book during one session, then return days later to continue reading, or may listen to segments of an audiobook across multiple sessions.

However, consuming digital content over multiple user sessions introduces several challenges. Users may experience a loss of continuity and immersion due to the passage of time between sessions, making it difficult to maintain context and recall previously encountered material. This can result in reduced comprehension, as users may struggle to remember earlier topics, characters, or plot points, and may find it challenging to re-engage with the digital content after a break.

Some implementations described herein provide enhanced summary generation of digital content. For example, the summary may be based on a portion of digital content that a user has previously interacted with. In some implementations, the summary may be further personalized based on user input, such as annotations, highlights, and/or notes created during previous user session. Accordingly, some implementations described herein provide a flexible and interactive approach that facilitates a summarization experience that is personalized and adaptable to a variety of user scenarios.

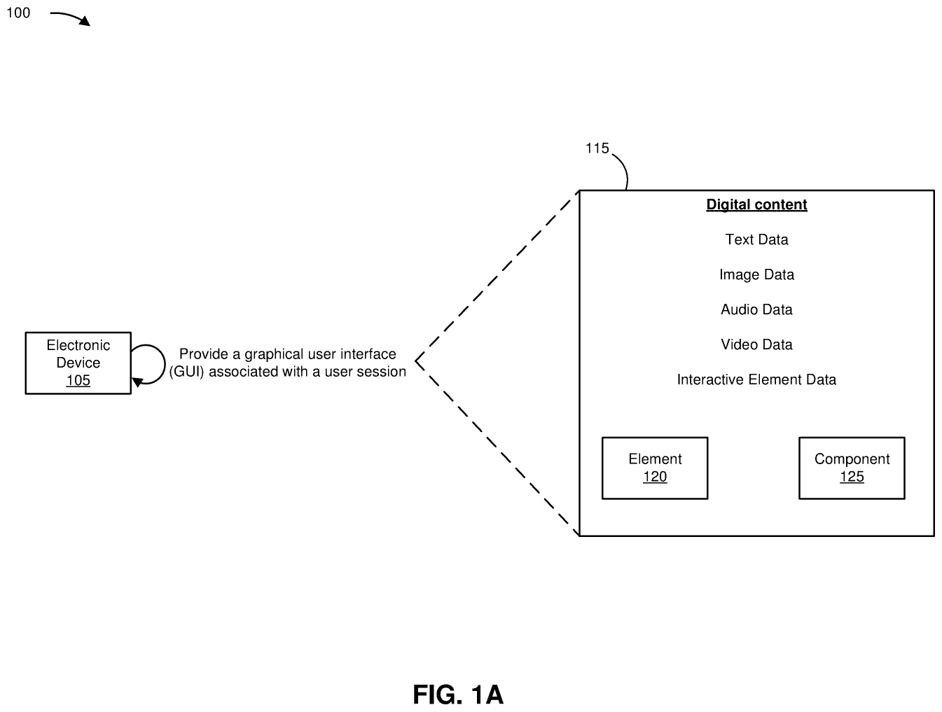

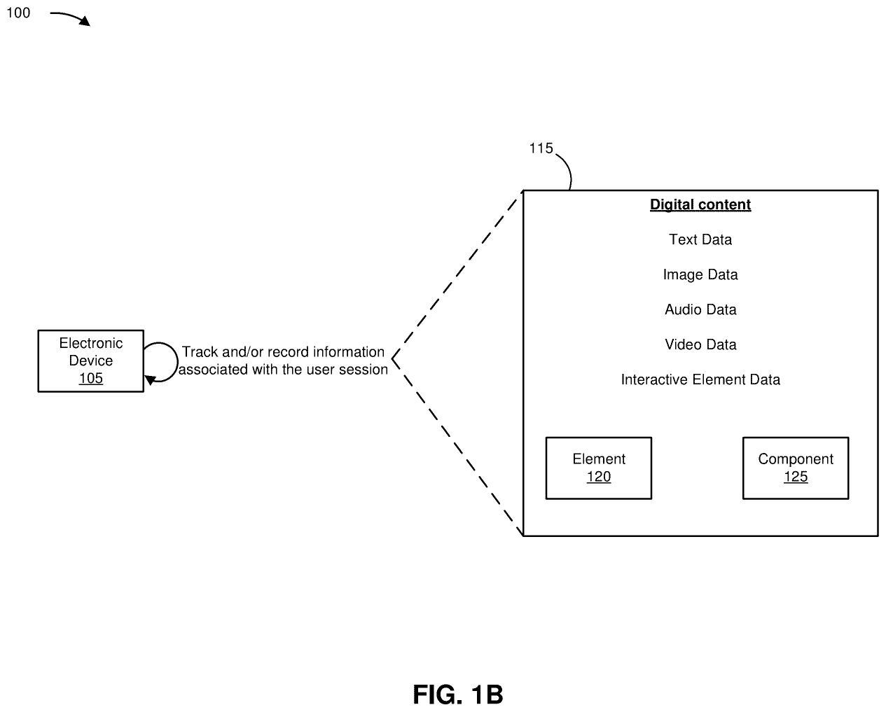

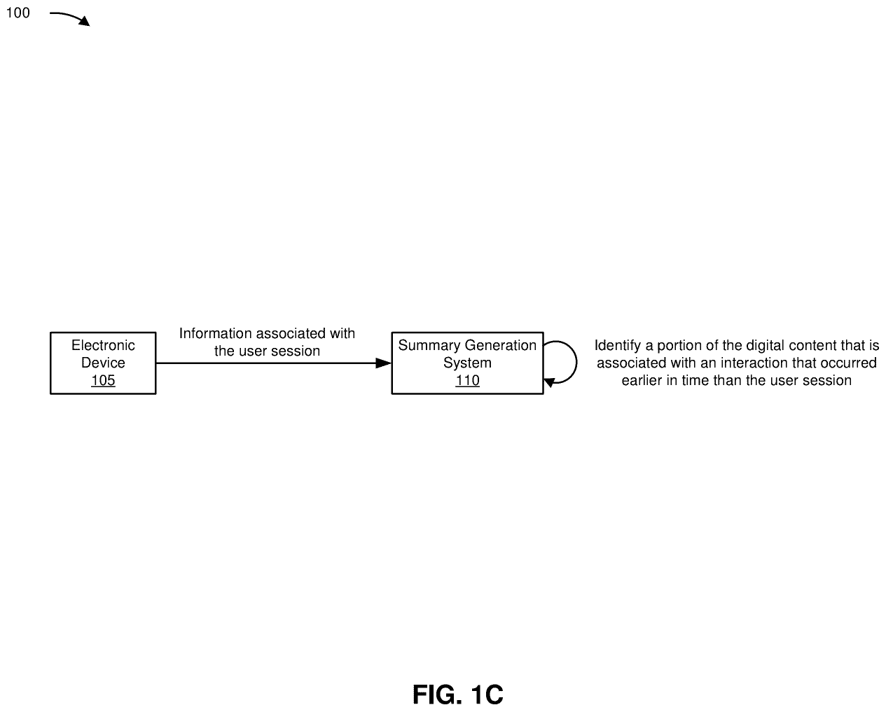

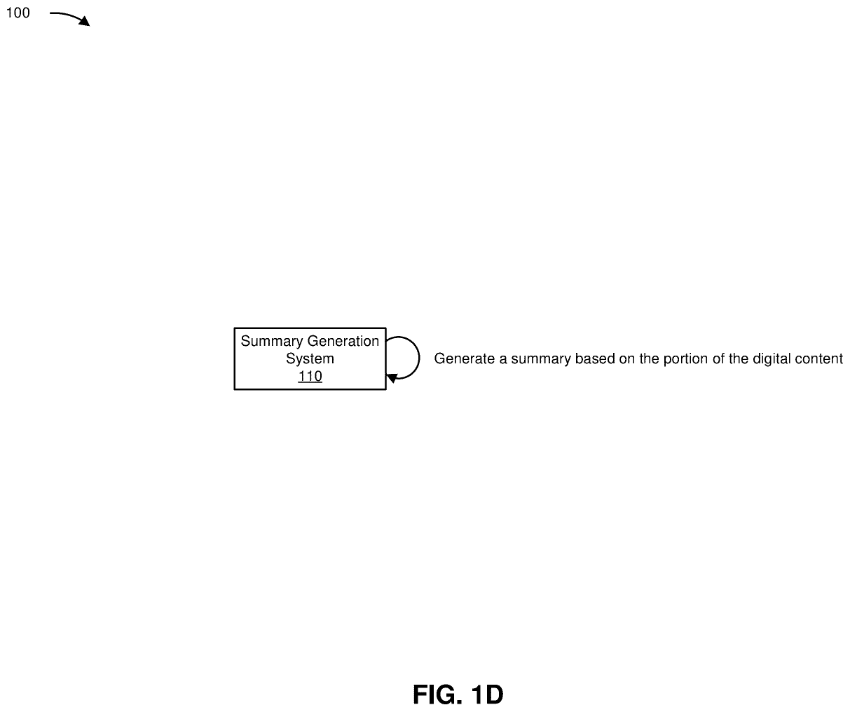

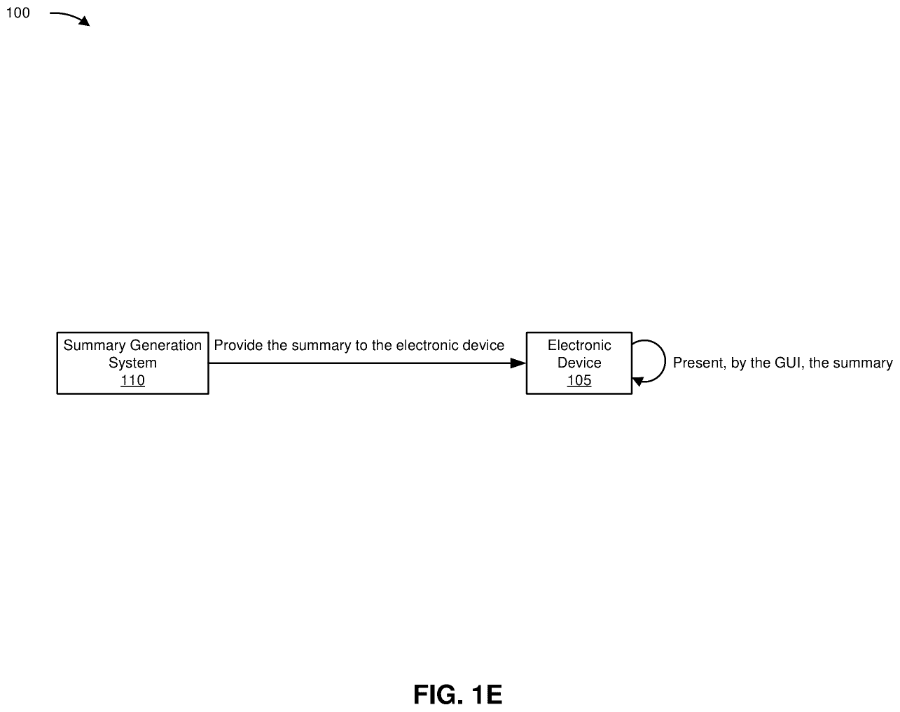

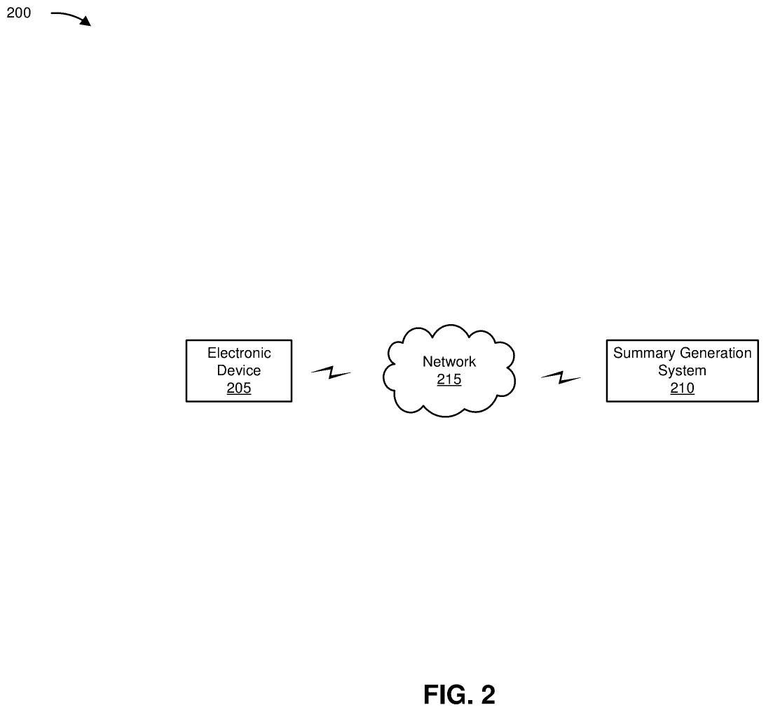

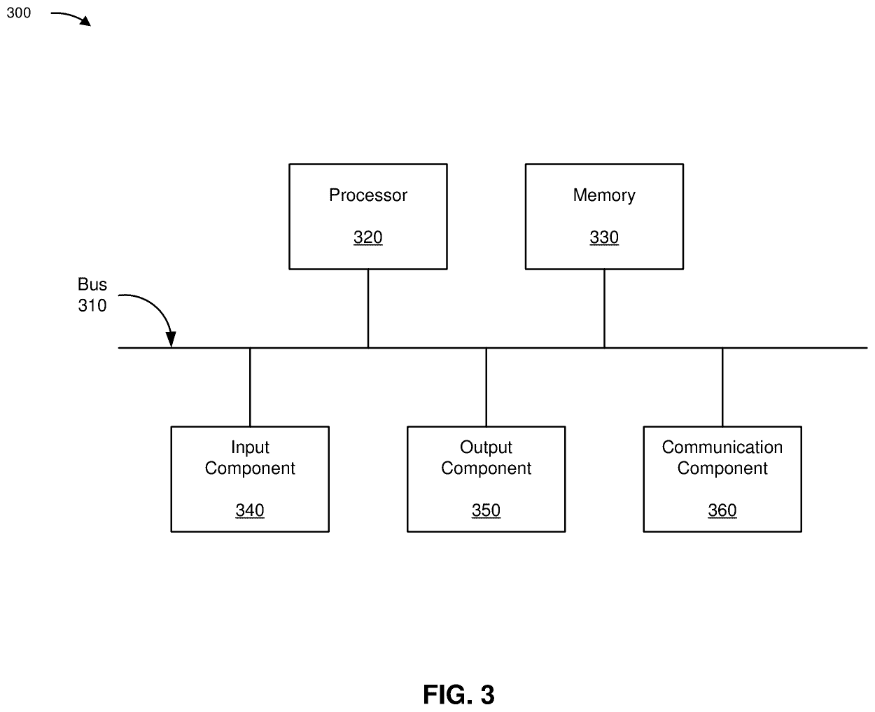

FIGS. 1A-1E are diagrams of an example 100 associated with enhanced summary generation of digital content. As shown in FIGS. 1A-1E, the example 100 includes an electronic device 105 and a summary generation system 110. These devices are described in more detail in connection with FIGS. 2 and 3.

As shown in FIG. 1A, the electronic device 105 may provide a graphical user interface (GUI) (e.g., shown as a GUI 115) associated with a user session. For example, the electronic device 105 may cause the GUI to be rendered on a display component of the device (e.g., a touchscreen display and/or an electronic ink (e-ink) panel). The GUI may include one or more elements (e.g., shown as an element 120 in FIG. 1A) configured to facilitate interaction with data presented via the GUI (e.g. one or more graphical elements), as described in more detail elsewhere herein.

In some implementations, the data presented via the GUI may be representative of digital content. For example, the digital content may include text (e.g., associated with electronic books (e-books), electronic articles, periodicals, reference materials, and/or captions), images (e.g., associated with photographs, illustrations, diagrams, tables, and/or embedded graphics), audio (e.g., associated with narration, sound effects, music, and/or embedded audio tracks), video (e.g., associated with animations, instructional clips, author interviews, and/or multimedia content), interactive elements (e.g., associated with fields, hyperlinks, quizzes, forms, and/or navigation controls), and/or user-generated content (e.g., annotations, highlights, bookmarks, handwritten notes, and/or sketches created by the user within the digital content), among other examples.

In some implementations, the user session may begin when the user causes the data representative of the digital content to be displayed via the GUI (e.g., the user may interact with the GUI to open an e-book, among other examples), and may continue as the user interacts with the digital content (e.g., by navigating, reading, annotating, highlighting, and/or otherwise engaging with the digital content).

In some implementations, the data representative of the digital content may include text data (e.g., main content, chapter titles, section headings, keywords, named entities, semantic embeddings, sentiment scores, reading progress, and/or metadata associated with text), image data (e.g., pixel values, image labels, feature embeddings, user markups, and/or metadata associated with an image), audio data (e.g., audio waveforms, frequency information, speaker embeddings, audio transcripts, and/or metadata associated with audio), video data (e.g., frame sequences, scene boundaries, motion features, video transcripts, and/or metadata associated with a video), interactive element data (e.g., hyperlink targets, quiz responses, form entries, and/or user selections), and/or user-generated content (e.g., user-created highlights, annotations, bookmarks, and/or handwritten notes linked to specific locations within the digital content), among other examples.

In some implementations, the data representative of the digital content may include information indicative of a structure, a concept, semantics, and/or a meaning of the digital content. For example, the data representative of the digital content may include structural components (e.g., chapters, sections, paragraphs, and/or page numbers), textual features (e.g., semantic embeddings, keywords, named entities, syntactic structures, and/or sentiment analysis), markup elements (e.g., headings, tables of contents, footnotes, references, dialogue indicators, and/or formatting tags), and/or metadata associated with the digital content (e.g., title, author, publisher, publication date, edition, language, genre, and/or digital format), among other examples.

In some implementations, the data representative of the digital content may include conceptual and/or semantic information associated with the digital content, such as characters, topics, ideas, themes, events, storylines, sentiment indicators, narrative arcs, stylistic elements, relationships between entities, inferred semantic constructs, and/or user-selected components (e.g., selected characters and/or concepts for targeted summarization), among other examples.

As shown in FIG. 1B, the electronic device 105 may track and/or record information associated with the user session. For example, the electronic device 105 may, during the user session, capture information associated with user interactions, progress, and/or engagement with the digital content, such as highlights, annotations, bookmarks, navigation history, and/or time spent in association with one or more sections of the digital content, among other examples.

In some implementations, to track and/or record the information with the user session, the electronic device 105 may detect one or more interactions with the digital content based on input received via the GUI. For example, the electronic device 105 may detect a text selection interaction (e.g., a touch gesture selecting a sentence), a highlighting interaction (e.g., a command to apply a yellow highlight), an annotation interaction (e.g., typed text entered via an on-screen keyboard and linked to a paragraph), an image interaction (e.g., pinch-to-zoom and pan gestures applied to a diagram), one or more navigation interactions (e.g., one or more swipe gestures to turn pages and/or taps of a table of contents link), and/or an interactive content interaction (e.g., a tap on a hyperlink and/or an input to a field), among other examples.

In some implementations, the electronic device 105 may be configured to perform one or more actions based on detecting the one or more interactions. For example, the electronic device 105 may be configured to classify each interaction by type (e.g., a highlight, an annotation, and/or an image manipulation), identify an element of the digital content (e.g., a sentence, a paragraph, an image, and/or an embedded object), and/or determine an input modality used to perform the interaction (e.g., touch, keyboard, and/or voice input), among other examples.

In some implementations, the electronic device 105 may be configured to associate metadata with the one or more interactions detected during the user session. For example, the metadata may include a page identifier, location information (e.g., a character offset and/or bounding box), a timestamp indicating when the interaction occurred, a user session identifier, an input modality (e.g., touch, stylus, keyboard, or voice input), an interaction type (e.g., text selection, highlight, annotation, image manipulation, navigation, or content engagement), user-related information (e.g., a user identifier and/or a user profile), an amount of time the user has interacted with one or more parts of the digital content (e.g., a duration on a given page or element), and/or an amount of text interacted with (e.g., a number of characters selected, highlighted, and/or annotated), among other examples.

For example, during a first user session, the electronic device 105 may detect interactions with pages 1-10 of an e-book based on input received via the GUI. For example, the electronic device 105 may detect a text selection interaction on page 1 (e.g., a touch gesture selecting a name of a character on page 1), a highlighting interaction on page 2 (e.g., a command to apply a yellow highlight to a sentence), an annotation interaction on page 3 (e.g., typed text entered via an on-screen keyboard and linked to a paragraph), an image interaction on page 7 (e.g., pinch-to-zoom and pan gestures applied to a diagram), navigation interactions (e.g., swipe gestures to turn pages), and an interactive content interaction on page 9 (e.g., a tap on a hyperlink).

The electronic device 105 may associate metadata with the interactions detected during the first user session. For example, the metadata may include a page identifier (e.g., corresponding to the text selection interaction that occurred on page 1 of the e-book), a selected text range (e.g., a character offset corresponding to the text selected by the user on page 1), information associated with the selected text (e.g., information associated with a character identified by the name selected by the user via the text selection interaction), a timestamp indicating when each interaction occurred (e.g., corresponding to a time the user performed the interaction), a session identifier (e.g., uniquely identifying the first user session), an input modality (e.g., touch, stylus, or keyboard), and an interaction type (e.g., text selection, highlight, annotation, image manipulation, navigation, or interactive content engagement), a highlighted sentence and a highlight color (e.g., corresponding to the highlighting interaction on page 2), annotation content and a target paragraph identifier (e.g., corresponding to the annotation created on page 3), an image identifier, zoom level, pan coordinates, and gesture type (e.g., corresponding to the image interaction on page 7), a starting page, destination page, and a navigation gesture (e.g., swipe left, corresponding to page navigation), an element identifier, tap coordinates, and activation timestamp (e.g., corresponding to the interactive content interaction on page 9), and a duration of user engagement per page (e.g., time spent on page 7) and a quantitative measure of text interacted with (e.g., number of words highlighted on page 2 or characters annotated on page 3).

As shown in FIG. 1C, the electronic device 105 may transmit, and the summary generation system 110 may receive, information associated with the user session. In some implementations, the information associated with the user session may include a portion of digital content that is associated with an interaction that occurred earlier in time than the user session. For example, when a user opens an e-book, the electronic device 105 may transmit data indicating which pages and/or sections the user has previously accessed, read, and/or interacted with (e.g., pages 1-10 of the e-book).

As further shown in FIG. 1C, the summary generation system 110 may identify the portion of the digital content that is associated with the interaction that occurred earlier in time than the user session. For example, if the user has interacted with pages 1-10 of an e-book during one or more previous user sessions, the summary generation system 110 may determine that pages 1-10 correspond to the portion of the digital content that is associated with the interaction that occurred earlier in time than the user session. Upon the user opening the e-book in a subsequent session, the summary generation system 110 may prompt the user to indicate whether the user would like to receive a summary based on the previously read pages 1-10. In this way, the summary generation system 110 may leverage historical data (e.g., historical interaction data) to identify and/or focus on digital content that is relevant to an ongoing consumption experience by the user, which facilitates continuity and enhances recall as the user resumes interaction with the digital content.

Accordingly, for example, multiple user sessions may occur over time, and the electronic device 105 may transmit, and the summary generation system 110 may receive, information associated with the multiple user sessions. The summary generation system 110 may aggregate, store, and/or manage the information associated with the multiple user sessions. Additionally, or alternatively, the summary generation system 110 may receive information associated with user sessions, of the multiple user sessions, from different devices (e.g., in addition to, or alternatively to, receiving the information associated with the user sessions from the electronic device 105). In this way, the summary generation system 110 may aggregate, store, and/or manage the information associated with the multiple user sessions across multiple user sessions and/or across multiple devices, among other examples.

In some implementations, the summary generation system 110 may store this information and associate it with the user (e.g., the summary generation system 110 may associate this information with a user profile and/or a record of user sessions associated with the user). This enables the electronic device 105 and/or the summary generation system 110 to maintain continuity and context across different user sessions. By aggregating and referencing information associated with the multiple user sessions, the summary generation system 110 may generate summaries (e.g., personalized summaries) and content tailored to an ongoing user experience (e.g., even as the user accesses the digital content over multiple, non-contiguous user sessions and/or across different devices).

In some implementations, a portion of the digital content may be associated with information that is generated, obtained, and/or derived in response to an interaction related to the portion of the digital content. For example, when a user highlights a passage, creates an annotation, and/or bookmarks a section, the electronic device 105 and/or the summary generation system 110 may generate metadata and/or engagement information (e.g., a timestamp, a user identifier, an interaction type, and/or a sentiment score, among other examples) associated with the portion of the digital content. This information may be stored and/or later retrieved to inform subsequent processing and/or summarization by the electronic device 105 and/or the summary generation system 110.

As shown in FIG. 1D, the summary generation system 110 may generate a summary based on the portion of the digital content that is associated with the interaction that occurred earlier in time than the user session.

In some implementations, the summary generation system 110 may utilize one or more artificial intelligence (AI) techniques to extract information from the digital content and/or the information associated with the user session (e.g., which may be indicative of user interactions with the digital content). For example, the summary generation system 110 may use one or more natural language processing (NLP), computer vision, and/or audio analysis techniques to obtain and/or process the information from the digital content and/or the information associated with the user session.

In some implementations, the summary generation system 110 may generate, using an AI model configured for summarization (e.g., of digital content), a summary based on the portion of the digital content. For example, training and usage of the AI model may be performed using a machine learning system.

The machine learning system may include, or may be included in, a computing device, a server, and/or a cloud computing environment. The AI model may be trained using a set of observations. The set of observations may be obtained from training data (e.g., historical data), such as data gathered during one or more processes described herein, including user interactions with digital content, user-generated annotations, highlights, bookmarks, and/or engagement metrics, among other examples.

In some implementations, the machine learning system may receive the set of observations (e.g., as input) from the electronic device 105, the summary generation system 110, and/or other sources of user interaction data, as described elsewhere herein.

The set of observations may include a feature set. The feature set may include a set of variables, and a variable may be referred to as a feature. A specific observation may include a set of variable values (or feature values) corresponding to the set of variables.

In some implementations, the machine learning system may determine variables for a set of observations and/or variable values for a specific observation based on input received from the electronic device 105, the summary generation system 110, and/or other sources. For example, the machine learning system may identify a feature set (e.g., one or more features and/or feature values) by extracting the feature set from structured data, by performing NLP to extract the feature set from unstructured data, and/or by receiving input from an operator.

As an example, a feature set for a set of observations may include features such as a type of digital content, a user engagement type (e.g., a highlight, an annotation, and/or a bookmark), time spent on content, user session duration, recency of interaction, and/or user preferences, among other examples.

For example, for a first observation, the features may have values such as “e-book,” “highlight,” “15 minutes,” “user session duration: 30 minutes,” “last interaction: 2 days ago,” and/or “preferred summary length: short.” These features and feature values are provided as examples and may differ in other examples. In some implementations, the features associated with an observation may vary depending on the type of digital content and/or user interaction.

The set of observations may be associated with a target variable. The target variable may represent a variable having a numeric value, a categorical value, a label, or a Boolean value. For example, the target variable may represent a summary quality score, a user satisfaction rating, and/or a classification of summary relevance. The target variable may be associated with a target variable value, and a target variable value may be specific to an observation.

The target variable may represent a value that the AI model is being trained to predict, and the feature set may represent the variables that are input to a trained AI model to predict a value for the target variable. The set of observations may include target variable values so that the AI model can be trained to recognize patterns in the feature set that lead to a target variable value. An AI model that is trained to predict a target variable value may be referred to as a supervised learning model.

In some implementations, the AI model may be trained on a set of observations that do not include a target variable. This may be referred to as an unsupervised learning model. In this case, the AI model may learn patterns from the set of observations without labeling or supervision, and may provide output that indicates such patterns, such as by using clustering and/or association to identify related groups of items within the set of observations.

The machine learning system may train the AI model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the AI model as a trained AI model to be used to analyze new observations.

As an example, the machine learning system may obtain training data for the set of observations based on historical records associated with a plurality of users, including user interactions with digital content, engagement patterns, and/or feedback on generated summaries.

The machine learning system may apply the trained AI model to a new observation, such as by receiving a new observation and inputting the new observation to the trained AI model. The new observation may include features such as a new user session, a specific digital content type, recent user interactions, and/or user preferences, among other examples. The machine learning system may apply the trained AI model to the new observation to generate an output, such as a generated summary, a predicted summary quality score, a recommendation for summary length and/or a content focus. The type of output may depend on the type of AI model and/or the type of machine learning task being performed.

Additionally, or alternatively, the output may include information that identifies a cluster to which the new observation belongs and/or information that indicates a degree of similarity between the new observation and one or more other observations, such as when unsupervised learning is employed.

In some implementations, the trained AI model may be re-trained using feedback information. For example, feedback may be provided to the AI model based on user ratings of generated summaries, user engagement with summaries, and/or other performance metrics, among other examples. The feedback may be associated with actions performed based on the summaries provided by the trained AI model and/or automated actions performed, or caused, by the trained AI model. In other words, the summaries and/or actions output by the trained AI model may be used as inputs to re-train the AI model (e.g., a feedback loop may be used to train and/or update the AI model).

In this way, the machine learning system may apply a rigorous and automated process to model user behaviors and preferences related to digital content summarization, including predicting variations in user engagement and/or satisfaction based on one or more contexts. The machine learning system may enable recognition and/or identification of a large number of features and feature values for a wide range of observations, thereby increasing accuracy and consistency and reducing delay associated with generating high-quality, personalized summaries of digital content.

Accordingly, for example, the summary generation system 110 may provide the portion of the digital content as an input to the AI model, and the summary generation system 110 may receive a summary based on the portion of the digital content as an output from the AI model.

In some implementations, the summary generation system 110 may provide a part of the portion of the digital content as input to the AI model. For example, the input may correspond to a segment defined by a time period of user interaction, a user-selected component, and/or a specified word count (e.g., a last 7,500 words interacted with by the user during one or more user sessions, among other examples). Additionally, or alternatively, the summary generation system 110 may incorporate information generated in response to user engagement, such as highlights, annotations, and/or metadata, to generate a summary that is contextually relevant and personalized to the user. In this way, the summary based on the portion of the digital content may be generated using a part of the portion of the digital content, selected according to relevant user session parameters and/or engagement data, among other examples.

In some implementations, the summary generation system 110 may prevent digital content that has not been interacted with by the user from being included in the summary generated by the AI model. In this way, the summary generation system 110 may ensure that only digital content previously accessed by the user is included in the summary (e.g., to prevent providing a summary related to content that the user has not consumed).

In some implementations, the summary may include information that is generated, obtained, and/or derived in response to an interaction related to the portion of the digital content. For example, the summary generation system 110 may incorporate user notes, highlights, annotations, and/or engagement data, among other examples, alongside the summary to provide additional context and value to the user. The summary may be displayed in a manner that matches one or more settings associated with the user and/or the user session, such as a font size and/or a font face, to enhance the consumption experience.

As shown in FIG. 1E, the summary generation system 110 may transmit, and the electronic device 105 may receive, the summary. As further shown in FIG. 1E, the electronic device 105 may present, by the GUI, the summary (e.g., to enable the user to view the summary).

In some implementations, the one or more elements of the GUI (e.g., the element 120) may be configured to receive an input that, when received via the GUI, initiates generation of the summary. For example, the one or more elements may be presented automatically based on a time period from a last interaction with the digital content (e.g., if the user has not read the same book in the last five days), and/or in response to a user interaction with the GUI which causes the element to be presented, such as a manual request from a menu. This supports both proactive and user-initiated summary generation based on the portion of the digital content.

Additionally, or alternatively, the GUI may enable the user to select a component (e.g., shown as a component 125) of the digital content, such as a character, a concept, and/or a section, and the summary generation system 110 may generate a summary that is based on the selected component. This allows the user to manually select the component to prompt the summary generation system 110 to generate a summary based on the selected component.

In some implementations, the summary generation system may provide a part of the portion of the digital content as an input to the AI model, where the part is determined based on a time period of the interaction, a duration of one or more user sessions (e.g., a last 24 hours of consumption of the digital content over the one or more user sessions), and/or a word count, and may be expanded to a closest full sentence (e.g. to avoid incomplete or inaccurate output).

In some implementations, a length of the summary may be configurable. For example, the one or more elements (e.g., the element 120) may be allow a user selection of a length of the summary to be generated by the summary generation system 110 (e.g., various summary selections associated with different lengths). In some implementations, a length of the summary may be configured to satisfy a threshold. For example, the length of the summary may be configured to be below a maximum word count, such as below 300 words or 500 words, among other examples. This flexible and interactive approach facilitates a summarization experience that is personalized and adaptable to a variety of user scenarios.

In some implementations, the GUI may prevent summaries (e.g., generated by the summary generation system 110 and presented by the electronic device 105 via the GUI) from being copied and/or exported (e.g., outside the user session). Additionally, or alternatively, the generation of and/or the presentation of the summaries may be configured to comply with one or more requirements, such as one or more requirements associated with sources of the digital content, among other examples.

FIG. 2 is a diagram of an example environment 200 in which systems and/or methods described herein may be implemented. As shown in FIG. 2, the environment 200 may include an electronic device 205, a summary generation system 210, and a network 215. Devices of the environment 200 may interconnect via wired connections, wireless connections, or a combination of wired and wireless connections.

The electronic device 205 may include one or more devices capable of receiving, generating, storing, processing, and/or providing information associated with enhanced summary generation of digital content, as described elsewhere herein. The electronic device 205 may include a communication device and/or a computing device. For example, the electronic device 205 may include an electronic reader (e-reader) device, a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The summary generation system 210 may include one or more devices capable of receiving, generating, storing, processing, providing, and/or routing information associated with enhanced summary generation of digital content, as described elsewhere herein. The summary generation system 210 may include a communication device and/or a computing device. For example, the summary generation system 210 may include a server, such as an application server, a client server, a web server, a database server, a host server, a proxy server, a virtual server (e.g., executing on computing hardware), or a server in a cloud computing system. In some implementations, the summary generation system 210 may include computing hardware used in a cloud computing environment.

The network 215 may include one or more wired and/or wireless networks. For example, the network 215 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 215 may enable communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 3 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with enhanced summary generation of digital content. The device 300 may correspond to the electronic device 105, the summary generation system 110, the electronic device 205, and/or the summary generation system 210. In some implementations, the electronic device 105, the summary generation system 110, the electronic device 205, and/or the summary generation system 210 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, and/or software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of, or in combination with, firmware and/or software instructions to perform one or more operations or processes described herein. Additionally, or alternatively, the processor 320 may be configured to perform one or more operations or processes described herein. Thus, implementations described herein are not limited to any specific combination of hardware circuitry, firmware, and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

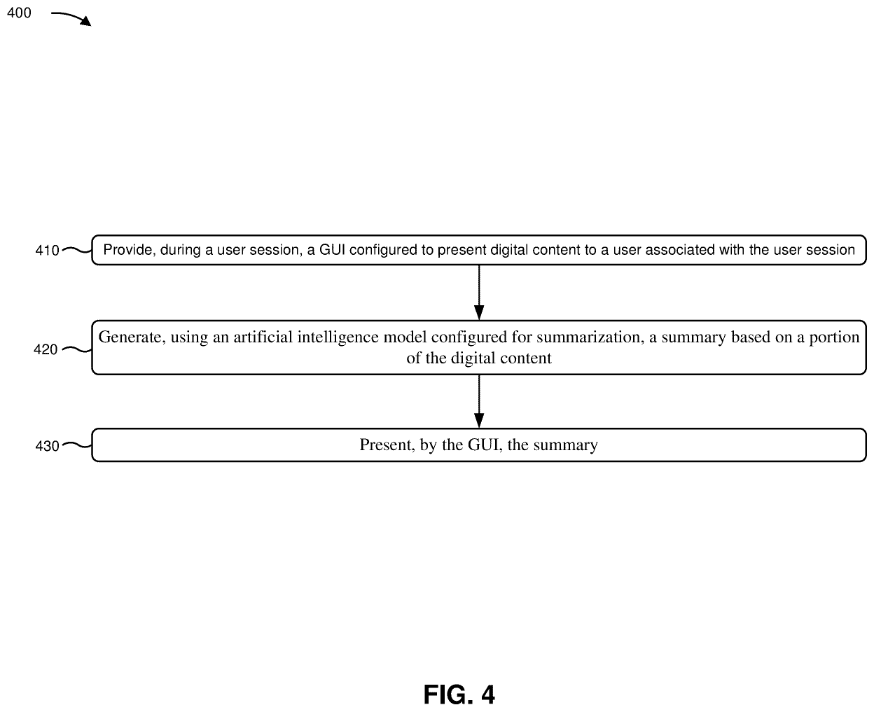

FIG. 4 is a flowchart of an example process 400 associated with enhanced digital content summary generation. In some implementations, one or more process blocks of FIG. 4 may be performed by an electronic device (e.g., the electronic device 105 and/or the electronic device 205). In some implementations, one or more process blocks of FIG. 4 may be performed by another device, or a group of devices, separate from or including the electronic device, such as a summary generation system (e.g., the summary generation system 110 and/or the summary generation system 210). Additionally, or alternatively, one or more process blocks of FIG. 4 may be performed by one or more components of the device 300, such as processor 320, the memory 330, the input component 340, the output component 350, and/or the communication component 360.

As shown in FIG. 4, the process 400 may include providing, during a user session, a GUI configured to present digital content to a user associated with the user session (block 410). For example, the electronic device may provide, during a user session, a GUI configured to present digital content to a user associated with the user session, as described in more detail elsewhere herein. In some implementations, wherein a portion of the digital content is associated with an interaction that occurred earlier in time than the user session.

As further shown in FIG. 4, the process 400 may include generating, using an AI model configured for summarization, a summary based on a portion of the digital content (block 420). For example, the summary generation system may generate, using an AI model configured for summarization, a summary based on a portion of the digital content, as described in more detail elsewhere herein.

As further shown in FIG. 4, the process 400 may include presenting, by the GUI, the summary (block 430). For example, the electronic device may present, by the GUI the summary, as described in more detail elsewhere herein.

Although FIG. 4 shows example blocks of the process 400, in some implementations, the process 400 may include additional blocks, fewer blocks, different blocks, or differently arranged blocks than those depicted in FIG. 4. Additionally, or alternatively, two or more of the blocks of the process 400 may be performed in parallel. The process 400 is an example of one process that may be performed by one or more devices described herein. These one or more devices may be configured to perform one or more other processes based on operations described herein, such as the operations described in connection with FIGS. 1A-1B. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and/or software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

Additionally, the functionality of the elements described herein may be implemented using circuitry or processing circuitry, including general-purpose processors, special-purpose processors, integrated circuits (ICs), and/or application-specific integrated circuits (ASICs), among other examples, configured and/or programmed to perform the disclosed functionality. A processor is a type of processing circuitry, as a processor includes transistors and/or other physical circuit components. A processor may execute instructions stored in memory, thereby operating as a programmed processor. As used in this disclosure, the term “circuitry” refers to physical hardware components that perform, or are configured (e.g., via firmware and/or software) to perform, the described functionality. Such hardware may include general-purpose processors, special-purpose processors, integrated circuits (ICs), application-specific integrated circuits (ASICs), programmable logic, and/or software-defined radio hardware. among other examples. When a processor or other reconfigurable hardware is used, “circuitry” may refer to a combination of the physical hardware and the associated firmware and/or software that configures the hardware to carry out the specified functions.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or described in this disclosure, these combinations are not intended to limit the disclosure of various implementations. In fact, many of these features may be combined in ways not specifically recited in the claims and/or described in this disclosure. Although each dependent claim listed below may directly depend on only one claim, the disclosure of various implementations includes each dependent claim in combination with every other claim in the claim set.

When an element is referred to herein as being “connected” or “coupled” to another element, it should be understood that the elements can be directly connected to the other element or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

As used herein, a phrase referring to “at least one of” a list of items refers to any combination and permutation of those items, including single members (e.g., an individual item in the list of items). As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list of items). As an example, “a, b, and/or c” is intended to cover a, b, c, a-b, a-c, b-c, and a-b-c.

No element, act, or instruction described herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used herein. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
providing, during a user session, a graphical user interface (GUI) configured to present digital content to a user associated with the user session,
wherein a portion of the digital content is associated with an interaction that occurred earlier in time than the user session;
generating, using an artificial intelligence model configured for summarization, a summary based on the portion of the digital content; and
presenting, by the GUI, the summary.

2. The method of claim 1, wherein the summary based on the portion of the digital content is generated based on a part of the portion of the digital content.

3. The method of claim 1, wherein the portion of the digital content is associated with information that is at least one of generated, obtained, or derived in response to an interaction related to the portion of the digital content, and
wherein the summary, generated using the artificial intelligence model configured for summarization, is further based on the information.

4. The method of claim 1, further comprising:
presenting, by the GUI, an element configured to receive an input that, when received via the GUI, initiates generation of the summary,
wherein the element is presented at least one of:
automatically based on a time period from a last interaction with the digital content, or
in response to a user interaction with the GUI which causes the element to be presented.

5. The method of claim 1, wherein the portion of the digital content includes a component, and
wherein the method further comprises:
presenting, by the GUI, an element configured to receive a selection of the component,
wherein the summary, generated using the artificial intelligence model configured for summarization, is further based on the component.

6. The method of claim 1, wherein generating, using the artificial intelligence model configured for summarization, the summary based on the portion of the digital content comprises:
providing a part of the portion of the digital content as an input to the artificial intelligence model such that the artificial intelligence model generates the summary based on the part of the portion of the digital content,
wherein the part of the portion of the digital content is based on a time period of the interaction.

7. The method of claim 1, wherein a length of the summary is configurable.

8. A device, comprising
a graphical user interface (GUI) configured to present digital content to a user; and
circuitry configured to:
provide, during a user session, the GUI to the user,
wherein a portion of the digital content is associated with an interaction that occurred earlier in time than the user session;
generate, using an artificial intelligence model configured for summarization, a summary based on the portion of the digital content; and
present, by the GUI, the summary.

9. The device of claim 8, wherein the summary based on the portion of the digital content is generated based on a part of the portion of the digital content.

10. The device of claim 8, wherein the portion of the digital content is associated with information that is at least one of generated, obtained, or derived in response to an interaction related to the portion of the digital content, and
wherein the summary, generated using the artificial intelligence model configured for summarization, is further based on the information.

11. The device of claim 8, wherein the circuitry is further configured to:
present, by the GUI, an element configured to receive an input that, when received via the GUI, initiates generation of the summary,
wherein the element is presented at least one of:
automatically based on a time period from a last interaction with the digital content, or
in response to a user interaction with the GUI which causes the element to be presented.

12. The device of claim 8, wherein the portion of the digital content includes a component, and
wherein the circuitry is further configured to:
present, by the GUI, an element configured to receive a selection of the component,
wherein the summary, generated using the artificial intelligence model configured for summarization, is further based on the component.

13. The device of claim 8, wherein generating, using the artificial intelligence model configured for summarization, the summary based on the portion of the digital content comprises:
providing a part of the portion of the digital content as an input to the artificial intelligence model such that the artificial intelligence model generates the summary based on the part of the portion of the digital content,
wherein the part of the portion of the digital content is based on a time period of the interaction.

14. The device of claim 8, wherein a length of the summary is configurable.

15. A non-transitory computer-readable medium storing a set of instructions, the set of instructions comprising:
one or more instructions that, when executed by one or more processors of a device, cause the device to:
provide, during a user session, a graphical user interface (GUI) configured to present digital content to a user associated with the user session,
wherein a portion of the digital content is associated with an interaction that occurred earlier in time than the user session;
generate, using an artificial intelligence model configured for summarization, a summary based on the portion of the digital content; and
present, by the GUI, the summary.

16. The non-transitory computer-readable medium of claim 15, wherein the portion of the digital content is associated with information generated in response to engagement with the portion of the digital content, and
wherein the summary, generated using the artificial intelligence model configured for summarization, is further based on the information.

17. The non-transitory computer-readable medium of claim 15, wherein the portion of the digital content is associated with information generated in response to engagement with the portion of the digital content, and
wherein the one or more instructions that, when executed by one or more processors of the device, further cause the device to:
present, by the GUI, the information with the summary.

18. The non-transitory computer-readable medium of claim 15, wherein the one or more instructions that, when executed by one or more processors of the device, further cause the device to:
present, by the GUI, an element configured to receive an input that, when received via the GUI, initiates generation of the summary,
wherein the element is presented at least one of:
automatically based on a time period from a last interaction with the digital content, or
in response to a user interaction with the GUI which causes the element to be presented.

19. The non-transitory computer-readable medium of claim 15, wherein the portion of the digital content includes a component, and
wherein the one or more instructions that, when executed by one or more processors of the device, further cause the device to:
present, by the GUI, an element configured to receive a selection of the component,
wherein the summary, generated using the artificial intelligence model configured for summarization, is further based on the component.

20. The non-transitory computer-readable medium of claim 15, wherein one or more instructions that, when executed by one or more processors of the device, cause the device to generate, using the artificial intelligence model configured for summarization, the summary based on the portion of the digital content, cause the device to:
provide a part of the portion of the digital content as an input to the artificial intelligence model such that the artificial intelligence model generates the summary based on the part of the portion of the digital content,
wherein the part of the portion of the digital content is based on a time period of the interaction.
